(19) United States
(12) Patent Application Publication
(10) Pub. No.: US 2002/0125320 A1
(43) Pub. Date: Sep. 12, 2002

(54) Device for scanning a code on an object

(75) Inventors: Gerrit Boersma, Odijk (NL); Cornelis Alexander Ernestus Van Der Hooft, Amersfoort (NL)

Correspondence Address: NEEDLE & ROSENBERG P C, 127 PEACHTREE STREET N E, ATLANTA, GA, 30303-1811, US

(73) Assignee: Scantech B.V.

(21) Appl. No.: 10/128,409

(22) Filed: Apr. 15, 2002

Related U.S. Application Data
(63) Continuation of application No. 09/380,518, filed on Jan. 19, 2000.
Application No. 09/380,518 is a 371 of international application No. PCT/NL98/00126, filed on Mar. 4, 1998.

(30) Foreign Application Priority Data
Mar. 5, 1997 (NL) 1005443

(51) Int. Cl. G06K 7/10; G06K 7/14

(52) U.S. Cl. 235/454

(57) ABSTRACT

The present invention comprises a device for scanning at least one code on an object, comprising two or more modules which each comprises an optics part for transmitting radiation and receiving radiation scattered by the code,and an electronics part for detecting the from the received radiation, wherein the relevant electronics part of two modules are mutually connected via an electric line and wherein at least one of the electronics part comprises a processor for processing the codes or portions thereof originating from both modules.

Scanners for scanning bar codes are now generally known, for instance for use at checkouts in supermarkets. Currently seen more and more are scanners which are capable of directing radiation on the object from two different directions, so that a cashier no longer has to make any ergonomically difficult wrist movement in order to move the objects with the pattern for scanning in a determined direction over a window.

The drawback of such scanners is that they are quite expensive to acquire, also on account of the development of this scanner of wholly new type. Users, including new buyers, are immediately faced with the choice of whether or not to place such a scanner in their stores or industrial environment.

The present invention provides a device for scanning at least one code on an object, comprising two or more modules which each comprise an optics part for transmitting radiation and receiving radiation scattered by the code, and an electronics part for detecting the code from the received radiation, wherein the relevant electronics parts of two modules are mutually connected via an electric line and wherein at least one of the electronics parts comprises a processor for processing the codes-or portions thereof originating from both modules.

The present invention further provides a method wherein the device is applied.

The present invention enables a user to first acquire a scanner of tested design, onto which a scanner, which at least in respect of the electronics is similarly constructed, can later be connected in simple manner.

An additional important advantage is the fact that with two or more coupled scanning devices the scanning process can continue even if one thereof requires repair.

In preference a first scanning device is provided beforehand with software which, by means of an external operation, i.e. wherein the housing of the scanner can remain closed, can make the first scanning device suitable for use with a second scanning device which is coupled thereto using one or more electrical cables. This external operation can for instance take place using a switch or other external conversion.

Further advantages, features and details of the present invention will be elucidated in the light of the following description of a preferred embodiment thereof with reference to the annexed drawing, in which:

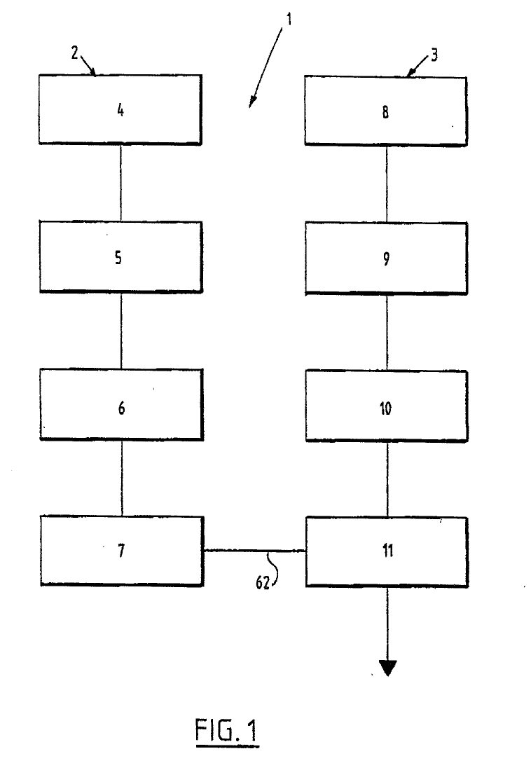

FIG. 1 shows a block diagram of a preferred embodiment of the device according to the present invention;

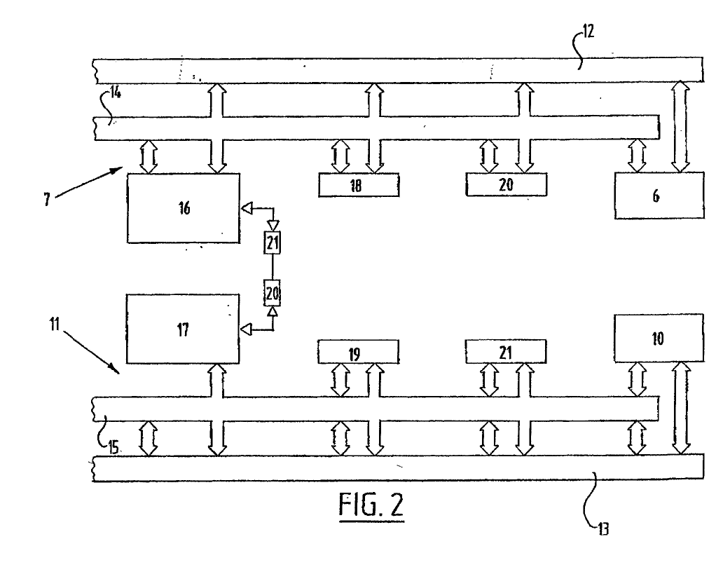

FIG. 2 shows a block diagram in more detail of a part of the device of FIG. 1;

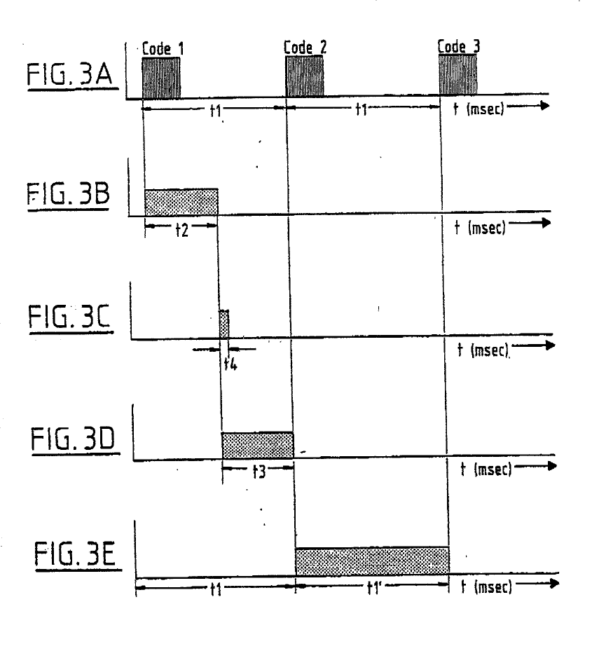

FIGS. 3A-E show respective graphs of a preferred embodiment of a method according to the present invention, wherein the device of FIGS. 1 and 2 is used; and

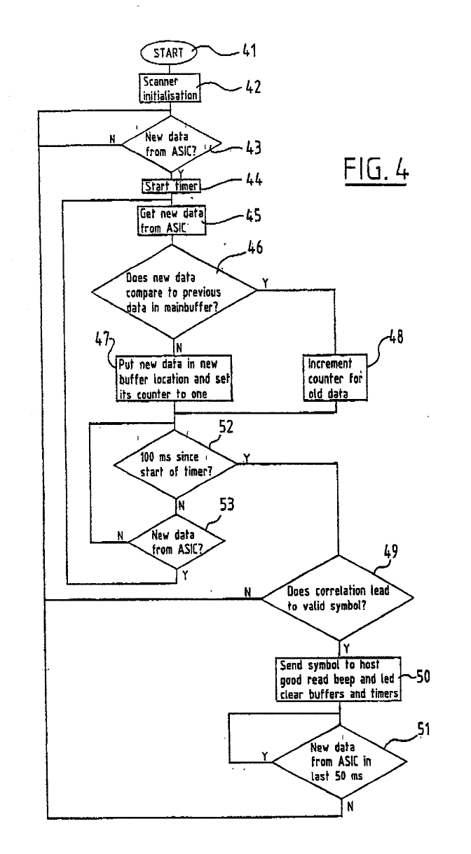

FIG. 4 shows a flow chart in which the method of FIGS. 3A-E is further elucidated.

A scanning device 1 (FIG. 1) comprises two respective modules 2, 3, for instance as described in the non-prepublished Netherlands patent applications 1003957 and 1004654 of applicant, wherein the former relates to a scanning device in upright position while the latter relates to a scanner in lying position.

Optics 4 of module 2 comprise the following components (not shown): a laser for transmitting the scanning radiation, a rotatably arranged polygonal mirror in addition to fixedly deployed mirrors for projecting the radiation outward through a window. Via these same mirrors the radiation scattered by a bar code is received by a radiation detector, whereafter schematically, designated analog electronics 5 provide amplification, filtering and detection of transitions from light to dark and dark to light transitions in the bar code.

In digital electronics which are connected to the analog electronics but preferably arranged on a separate board, the time duration between transitions from light to dark and transitions from dark to light are determined and if possible a bar code is recognized from a series of such times, wherein this may also be a portion thereof, for instance half a bar code. A microprocessor part 7 is connected to the digital electronics 6. In similar manner a module 3 comprises optics 8, for instance embodied slightly differently from the optics 4 on account of the respective horizontal and vertical arrangement, analog electronics 9, digital electronics 10 and a microprocessor part 11, wherein microprocessor 11 produces an output signal for a checkout system if a whole bar code is recognized, wherein a bleep signal and a light signal are generated. The parts 5 and 9, 6 and 10 and 7 and 11 are embodied as similarly as possible for each of the modules, which reduces production costs. Microprocessor parts 7 and 11 are coupled via a serial port present on the microprocessor via a serial connecting line 62.

In a preferred embodiment (not shown) the processor part 11 can be connected as master to more than one processor part, i.e. such as slave 7.

It is further noted that in the above stated preferred, embodiment the scanner 3 disposed in lying position is connected to the cash register. It is also conceivable for the vertically disposed scanner to be connected to the cash register, while it is equally conceivable for each of the scanners to be connected individually thereto.

In a first preferred embodiment the decoded codes or portions thereof are immediately transmitted by processor part 7 to master 11 which evaluates theme codes together with the codes from digital electronics 10 and determines whether a particular code has been recognized.

As will become apparent from the following, this merging requires only little modification of existing software, since the processing principle in processor 11 does not change, or hardly so.

It is likewise conceivable when a single scanner is installed for the required software to be already included therein for a possible later connection to a second scanner. It is then preferably possible, using an external operation, to adjust the scanner to the fact that it now comprises a master and a slave scanning device.

The processor part 7 (FIG. 2) and processor part 11 each comprise an address bus 12 respectively 13 in addition to a data bus 14 respectively 15 onto which are connected microprocessors 16 respectively 17, in addition to ROMs 18 respectively 19, RAMs 20 respectively 21 and digital electronics 6 respectively 10, which in the present embodiment comprise an ASIC. Processors 16 and 17 are mutually connected via interfaces 20. respectively 21 via a serial port.

With reference to FIGS. 3A-3E and FIG. 4 the operation of the device according to FIGS. 1 and 2 will be elucidated below.

FIG. 3A shows that for time periods t1, in the present case 750 ms, one code at a time is analyzed and/or recognized (or no code is recognized). For a time period t2 a search is made by processor 17 of module part 11 as to whether a code or portion thereof originating from ASIC 10 or ASIC 6 via processor 16 is recognized. t2 amounts for instance to 100 ms. For a time period t3 (FIG. 3D) recognition is blocked, wherein a sound and/or light signal is also generated for a short period of for instance 60 ms (t4, FIG. 3C). In the example of FIG. 3D, t3 has a duration of (t1-t2)=650 ms. Further indicated in FIG. 3E is that, after a period t1, recognition of the same code originating with a probability bordering on certainty from the same product remains blocked for the subsequent period t1.

As will be apparent from the description above, the operation of the software in processor 17 is similar to the situation where only codes or code fragments originating from the associated ASIC 10 were to be available.

In the flow chart of FIG. 4 the scanner is initialized after the start at 42, whereafter it, is determined at 43 whether or not new data is available from the ASIC, whereafter in the affirmative case a timer 44 is started. At 45 new data is retrieved from the ASIC and at 46 this is compared with previous data in the main buffer. If it is the same as the data stored earlier in the RAM, a counter for the old data is incremented at 48. If the data is not the, same, the new data is placed in the new buffer and the counter is set to one at 47. At 52 is determined whether or not 100 ms have elapsed since the start of the timer, while at 53 is checked whether new data originating from the ASIC is available.

If at 49 no valid symbol is found, the procedure is repeated, while in an affirmative case the found symbol is transmitted at 50 to the checkout system, a sound and light signal is generated and the buffer and timer are cleared. After a wait loop at 51 in order to complete the last 650 ms, a new cycle is then started.

The present invention is not limited to the. above described preferred embodiment thereof. The rights applied for are defined by the following claims, within the scope of which many modifications can be envisaged by a skilled person in this technical field.

It is noted in this respect that the above described embodiment relates to coupling of a horizontal and a vertical scanner, wherein one of the two functions as master and the other as slave. It is however possible in similar manner to mutually couple two or more horizontal or vertical scanners, while it is also conceivable to have mutually coupled microprocessors perform multiple tasks, which may be desirable for instance for industrial applications.

In such an application, for instance for recognition of CDs or books on a conveyor belt, two or more scanning devices can be actively coupled to a presence sensor such as a photocell in order to generate a signal when the object is present. The scanning devices either give a recognition signal or not when the bar code is read, from which it can then be concluded, as the case arises, that an object which has passed by has not been recognized.

1. Device for scanning at least one code on an object, comprising two or more modules which each comprise an optics part for transmitting radiation and receiving radiation scattered by the code, and an electronics part for detecting the code from the received radiation, wherein the relevant electronics parts of two modules are mutually connected via an electric line and wherein at least one of the electronics parts comprises a processor for processing the codes or portions thereof originating from both modules.

2. Device as claimed in claim 1, wherein the electronics parts comprise an analog operating part for amplification, filtering and detection of transitions from light to dark and a digital part in which the time period between the transitions determined by the analog part is detected.

3. Device as claimed in claim 2, wherein the digital part comprises an ASIC (Application specific Integrated Circuit) in addition to the processor.

4. Device as claimed in claim 1, 2 or 3, wherein the digital part of the electronics part of each of the modules is substantially the same and wherein the electronics parts are mutually connected via a serial port of each of the associated processors.

5. Method for scanning at least one code on an object, wherein a device as claimed in any of the claims 1-4 is applied.

6. Method as claimed in claim 5, wherein for a certain sampling time the codes or portions thereof are or are not detected by the processor and after the sampling time a certain blocking time is observed.

7. Method as claimed in claim 5 or 6, wherein after the blocking time a second blocking time is observed for recognition of an identical code-portion.

8. Scanning module comprising an optics part and an electronics part, wherein the electronics part is adapted such that it can be connected to the electronics part of a corresponding scanning module.

9. Scanning module evidently suitable for a device as claimed in any of the claims 1-4.

10. Device as claimed in claim 4, wherein the hardware of the electronics part is wholly identical.

11. Device as claimed in claim 10, wherein in at least one of the scanning devices software for mutual coupling is stored in the hardware.

12. Device as claimed in any of the claims 1-4 and/or claim 10 or 11, wherein in one of the modules or scanning devices is incorporated software which can be externally activated such that it is able to process data originating from two coupled modules.
